(19) United States
(12) Patent Application Publication
(10) Pub. No.: US 2026/0333407 A1
(43) Pub. Date: Oct. 22, 2026

(54) DYNAMIC SPECTRUM ALLOCATION METHOD AND SYSTEM FOR A TELECOMMUNICATION NETWORK

(71) Applicant: CABLE TELEVISION LABORATORIES, INC., Louisville, CO (US)

(72) Inventor: Omkar Shripad Dharmadhikari, Denver, CO (US)

(21) Appl. No.: 19/651,284

(22) Filed: Apr. 17, 2026

Related U.S. Application Data
(60) Provisional application No. 63/790,696, filed on Apr. 17, 2025.

(51) Int. Cl. H04W 72/541; H04W 72/0453

(52) U.S. Cl. CPC H04W 72/541; H04W 72/0453

(57) ABSTRACT

Dynamic spectrum allocation methods and systems for a telecommunication network are provided. receiving, by a spectrum allocation engine of the telecommunication network: An available frequency in a frequency spectrum, an interference source, and network performance data are received by a spectrum allocation engine and inputted into a machine learning model (MLM). The MLM is configured to output a prediction comprising a predicted network performance and a predicted interference, which are transmitted (along with the available frequency and network performance data) to an adaptive channel manager configured to dynamically allocate channels in the frequency spectrum. The adaptive channel manager adjusts an allocation of the channels based on the available frequency, the network performance data, and the prediction to yield adjusted channels and assigns the adjusted channels to corresponding devices in the telecommunication network.

### CROSS REFERENCE TO RELATED APPLICATIONS

This application claims the benefit of and priority to U.S. Provisional Application No. 63/790,696, filed on Apr. 17, 2025, which is incorporated herein by reference in its entirety.

### BACKGROUND

The field of the disclosure relates generally to dynamic spectrum allocation, and more particularly, to dynamic spectrum allocation methods and systems for a telecommunication network.

Wireless telecommunication networks increasingly operate in congested and interference-prone spectrum environments, making static or manually configured spectrum allocation difficult to maintain reliable performance. Modern networks must accommodate diverse technologies (e.g., 5G/6G, Wi-Fi 7/8) and large numbers of heterogeneous devices, including dense Internet of Things (IoT) deployments, all of which generate dynamic and unpredictable spectrum usage patterns.

Conventional spectrum management techniques involving static allocation lack the ability to continuously sense real-time conditions, predict interference events, or adapt allocation decisions quickly enough to prevent degradation in throughput, latency, and overall quality of service. As a result, there is a need for an adaptive and dynamic system capable of autonomously managing spectrum resources in real-time while addressing interference, performance variability, and the complexity of modern wireless environments.

### SUMMARY

Dynamic spectrum allocation systems and methods for a telecommunication network are provided. The dynamic spectrum allocation systems and methods dynamically adjust the allocation of channels in a frequency spectrum in real-time based on anticipated network performances and interferences as predicted using artificial intelligence and machine learning. The dynamic spectrum allocation systems and methods can beneficially optimize the use of available wireless spectrum and adapt to changing network conditions and user demands while reducing interference and enhancing network performance.

A method of dynamic spectrum allocation for a telecommunication network according to at least one embodiment of the present disclosure comprises receiving, by a spectrum allocation engine of the telecommunication network: at least one available frequency in a frequency spectrum and at least one interference source from a spectrum module, network performance data from a network module; inputting, by the spectrum allocation engine, the at least one interference source and the network performance data into a machine learning model (MLM), the MLM configured to output a prediction comprising a predicted network performance and a predicted interference based on the at least one interference source and the network performance data; receiving, by the spectrum allocation engine, the prediction as output from the MLM; and transmitting, by the spectrum allocation engine, the at least one available frequency, the network performance data, and the prediction to an adaptive channel manager configured to dynamically allocate one or more channels in the frequency spectrum by executing a plurality of operations comprising: adjusting an allocation of the one or more channels based on the at least one available frequency, the network performance data, and the prediction to yield one or more adjusted channels, wherein the adjusting is configured to minimize the predicted interference and to optimize the predicted network performances; and assigning the one or more adjusted channels to a corresponding one or more devices in the telecommunication network.

Any of the aspects herein, wherein the adjusting comprises at least one of avoiding channels with an expected co-channel or adjacent-channel interference that exceeds a predetermined interference threshold, selecting a channel with a predicted noise and congestion level lower than a current predicted noise and congestion level, or distributing devices across channels to reduce channel contention and overlapping transmissions.

Any of the aspects herein, wherein the MLM uses reinforcement learning (RL) and is trained using historical data as training data.

Any of the aspects herein, wherein the MLM is fined-tuned using real-time data.

Any of the aspects herein, wherein the adjusting the allocation of the one or more channels is further based on one or more user inputs.

Any of the aspects herein, further comprising: transmitting, by the spectrum allocation engine, the at least one available frequency, the at least one interference source, and the network performance data to an interference mitigation controller configured to mitigate interference by executing a plurality of operations comprising: detecting the interference based on the at least one interference source and the network performance data to yield a detected interference; adjusting one or more interference factors based on the detected interference, the network performance data, and the at least one available frequency to yield one or more adjusted interference factors, wherein the adjusting is configured to minimize the detected interference; and applying the one or more adjusted interference factors to the one or more devices of the telecommunication network.

Any of the aspects herein, wherein adjusting the one or more interference factors includes at least one of dynamic frequency selection, adjusting a transmission power, beamforming, or adjusting the allocation of the one or more channels.

Any of the aspects herein, wherein the at least one frequency band is detected by a spectrum sensor using at least one of energy detection, matched filter detection, cyclostationary feature detection, waveform-based sensing, or cooperative sensing.

Any of the aspects herein, wherein the network performance data is generated from network sensor data received and processed by the network module from a network sensor.

Any of the aspects herein, wherein the frequency spectrum comprises a wireless frequency spectrum.

A method of mitigating interference in a telecommunication network according to at least one embodiment of the present disclosure comprises receiving, by a spectrum allocation engine of the telecommunication network: at least one available frequency and at least one interference source from a spectrum module, network performance data from a network module; transmitting, by the spectrum allocation engine, the at least one available frequency, the at least one interference source, and the network performance data to an interference mitigation controller configured to mitigate interference by executing a plurality of operations comprising: detecting the interference based on the at least one interference source and the network performance data to yield a detected interference; adjusting one or more interference factors based on the detected interference, the network performance data, and the at least one available frequency to yield one or more adjusted interference factors, wherein the adjusting is configured to minimize the detected interference; and applying the one or more adjusted interference factors to one or more devices of the telecommunication network.

Any of the aspects herein, wherein adjusting the one or more interference factors includes at least one of dynamic frequency selection, adjusting a transmission power, beamforming, or adjusting the allocation of the one or more channels.

Any of the aspects herein, wherein the at least one frequency band is detected by a spectrum sensor using at least one of energy detection, matched filter detection, cyclostationary feature detection, waveform-based sensing, or cooperative sensing.

Any of the aspects herein, wherein the network performance data is generated from network sensor data received and processed by the network module from a network sensor.

Any of the aspects herein, wherein the frequency spectrum comprises a wireless frequency spectrum.

Any of the aspects herein, further comprising: inputting, by the spectrum allocation engine, the at least one interference source and the network performance data into a machine learning model (MLM), the MLM configured to output a prediction comprising a predicted network performance and a predicted interference based on the at least one interference source and the network performance data; receiving, by the spectrum allocation engine, the prediction as output from the MLM; and transmitting, by the spectrum allocation engine, the at least one available frequency, the network performance data, and the prediction to an adaptive channel manager configured to dynamically allocate one or more channels in the frequency spectrum by executing a plurality of operations comprising: adjusting an allocation of the one or more channels based on the at least one available frequency, the network performance data, and the prediction to yield one or more adjusted channels, wherein the adjusting is configured to minimize the predicted interference and to optimize the predicted network performances; and assigning the one or more adjusted channels to a corresponding one or more devices in the telecommunication network.

Any of the aspects herein, wherein the adjusting comprises at least one of avoiding channels with an expected co-channel or adjacent-channel interference that exceeds a predetermined interference threshold, selecting a channel with a predicted noise and congestion level lower than a current predicted noise and congestion level, or distributing devices across channels to reduce channel contention and overlapping transmissions.

Any of the aspects herein, wherein the MLM uses reinforcement learning (RL) and is trained using historical data as training data.

Any of the aspects herein, wherein the adjusting the allocation of the one or more channels is further based on one or more user inputs.

A dynamic spectrum allocation system for a telecommunication network according to at least one embodiment of the present disclosure comprises a spectrum module comprising at least one sensor, the spectrum module configured to determine at least one available frequency in a frequency spectrum and at least one interference source based on sensor data received from the at least one spectrum sensor; a network module comprising at least one network sensor, the network module configured to determine network performance data based on network sensor data received from the at least one network sensor; a machine learning model (MLM) configured to output a prediction comprising a predicted future network performance and a predicted interference based on the at least one interference source and the network performance data received as input; an adaptive channel manager configured to dynamically allocate one or more channels in the frequency spectrum by executing a plurality of operations comprising: adjusting an allocation of the one or more channels based on the at least one available frequency, the network performance data, and the prediction to yield one or more adjusted channels, wherein the adjusting is configured to minimize the predicted interference and to optimize the predicted network performances; and assigning the one or more adjusted channels to one or more corresponding devices of the telecommunication network; and a spectrum allocation engine configured to: input the at least one interference source and the network performance data into the MLM; and transmit the prediction received as output from the MLM, the at least one available frequency, and the network performance data to the adaptive channel manager. The details of one or more aspects of the disclosure are set forth in the accompanying drawings and the description below. Other features, objects, and advantages of the techniques described in this disclosure will be apparent from the description and drawings, and from the claims.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of a dynamic spectrum allocation system for a telecommunication network according to at least one embodiment of the present disclosure;

FIG. 2 is a dataflow of a dynamic spectrum allocation system for a telecommunication network according to at least one embodiment of the present disclosure;

FIG. 3 is a flowchart according to at least one embodiment of the present disclosure;

FIG. 4 is a flowchart according to at least one embodiment of the present disclosure;

FIG. 5A shows an example of a computing system, in accordance with one or more embodiments; and

FIG. 5B shows an example of a network, in accordance with one or more embodiments.

### DETAILED DESCRIPTION

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (i.e., X₁ and X₂) as well as a combination of elements selected from two or more classes (i.e., Y₁ and Zₒ).

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before”, “after”, “single”, and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

As used herein, the term “database” may refer to either a body of data, a relational database management system (RDBMS), or to both, and may include a collection of data including hierarchical databases, relational databases, flat file databases, object-relational databases, object-oriented databases, and/or another structured collection of records or data that is stored in a computer system.

As used herein, the terms “processor” and “computer” and related terms, i.e., “processing device”, “computing device”, and “controller” are not limited to just those integrated circuits referred to in the art as a computer, but broadly refers to a microcontroller, a microcomputer, a programmable logic controller (PLC), an application specific integrated circuit (ASIC), and other programmable circuits, and these terms are used interchangeably herein. In the embodiments described herein, memory may include, but is not limited to, a computer-readable medium, such as a random access memory (RAM), and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary embodiment, additional output channels may include, but not be limited to, an operator interface monitor.

Further, as used herein, the terms “software” and “firmware” are interchangeable, and include computer program storage in memory for execution by personal computers, workstations, clients, and servers.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “telecommunication network” or refers to a system of interconnected devices connected by links (e.g., cable, fiber, wireless, etc.) over which data can be transmitted between the interconnected devices. The telecommunication network can include, for example, cable networks, hybrid fiber-coaxial networks, fiber networks, a radio frequency network, any wired network, any wireless network, or any hybrid network.

The person of ordinary skill in the art will understand that the term “wireless,” as used herein in the context of optical transmission and communications, including free space optics (FSO), generally refers to the absence of a substantially physical transport medium, such as a wired transport, a coaxial cable, or an optical fiber or fiber optic cable.

As used herein, the term “data center” generally refers to a facility or dedicated physical location used for housing electronic equipment and/or computer systems and associated components, i.e., for communications, data storage, etc. A data center may include numerous redundant or backup components within the infrastructure thereof to provide power, communication, control, and/or security to the multiple components and/or subsystems contained therein. A physical data center may be located within a single housing facility, or may be distributed among a plurality of co-located or interconnected facilities. A ‘virtual data center’ is a non-tangible abstraction of a physical data center in a software-defined environment, such as software-defined networking (SDN) or software-defined storage (SDS), typically operated using at least one physical server utilizing a hypervisor. A data center may include as many as thousands of physical servers connected by a high-speed network.

As used herein, the term “spectrum” generally refers to an electromagnetic (EM) spectrum and the full range of electromagnetic radiation. The spectrum is divided into bands that include radio waves, microwaves, infrared, visible light, ultraviolet, X-rays, and gamma rays. In the context of telecommunication networks, the term “spectrum” or “wireless spectrum” refers to the subset of electromagnetic frequencies in the spectrum allocated or available for conveying information-bearing signals, irrespective of whether such frequencies are licensed, unlicensed, shared, or dynamically assigned.

The term “Artificial Intelligence” or “AI” refers to one or more computer-implemented systems, models, engines, or processes configured to perform tasks that include, but are not limited to, learning from data, identifying patterns, reasoning, predicting outcomes, classifying information, generating outputs, making decisions, or adapting behavior based on experience or inputs, using deterministic or probabilistic techniques. AI includes, for example, software and/or hardware systems that employ mathematical models, algorithms, heuristics, statistical methods, machine learning techniques, neural networks, rule-based logic, optimization routines, or combinations thereof, to process data and produce outputs. AI also includes machine learning models (MLM) capable of training, retraining, inference, or execution, including supervised, unsupervised, semi-supervised, reinforcement, or hybrid learning techniques, as well as non-learning computational approaches, to generate, for example, predictions, recommendations, classifications, or control signals.

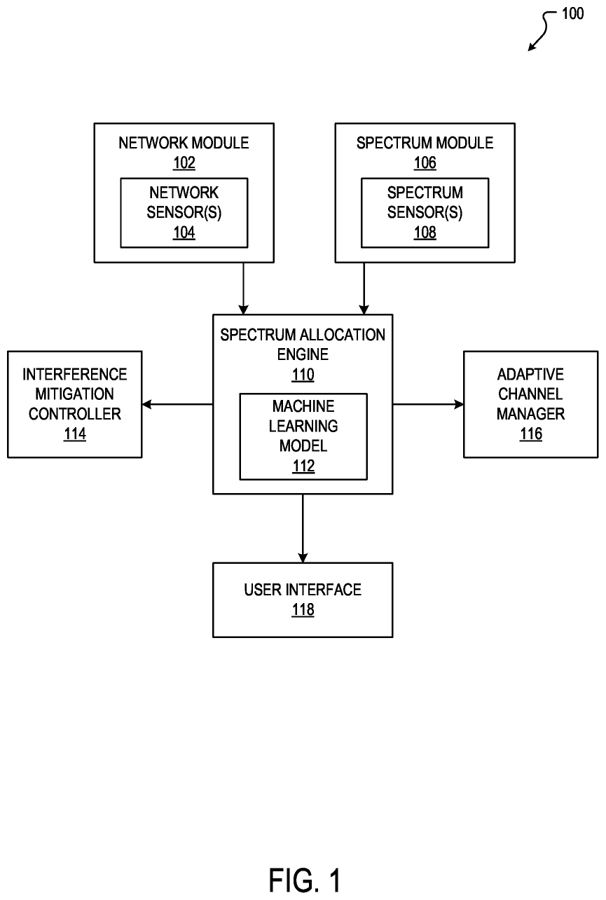

Turning to the Figures, FIG. 1 is a block diagram of a dynamic spectrum allocation system (100) (also referred to as “the system (100)”), according to at least one embodiment of the present disclosure. The system (100) is designed to optimize use of available wireless spectrum in a telecommunication network by dynamically adjusting an allocation of channels and frequencies in the wireless spectrum in real-time based on network performance, anticipated interference, and/or user demands. More specifically, the system (100) uses machine learning models (MLM) to predict future network performance and anticipate interference such that channels and frequencies in the wireless spectrum can be allocated to minimize the predicted interference and optimize the predicted network performance. Thus, the system (100) aims to reduce interference in the telecommunication network, enhance network performance, and improve the user experience.

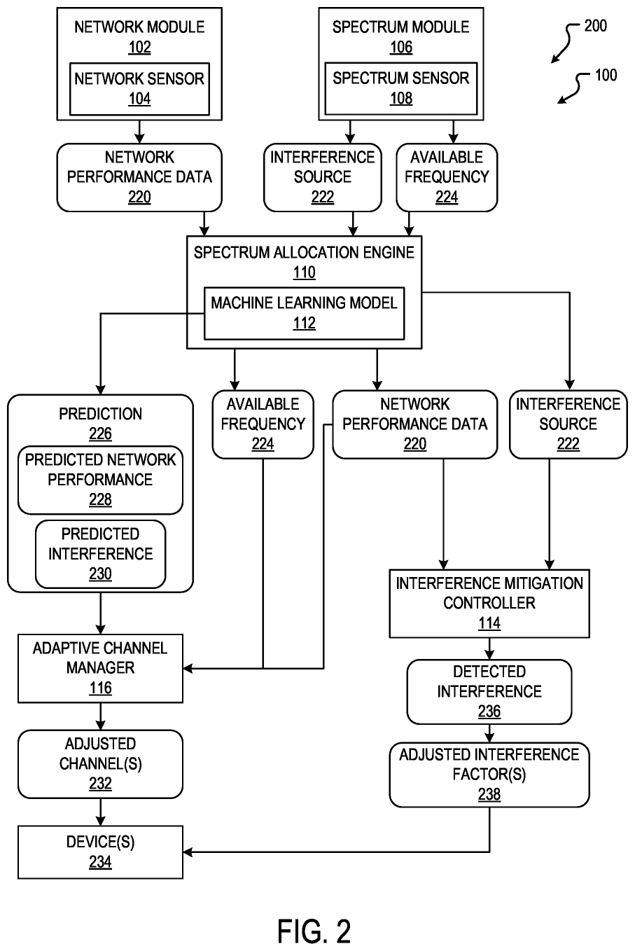

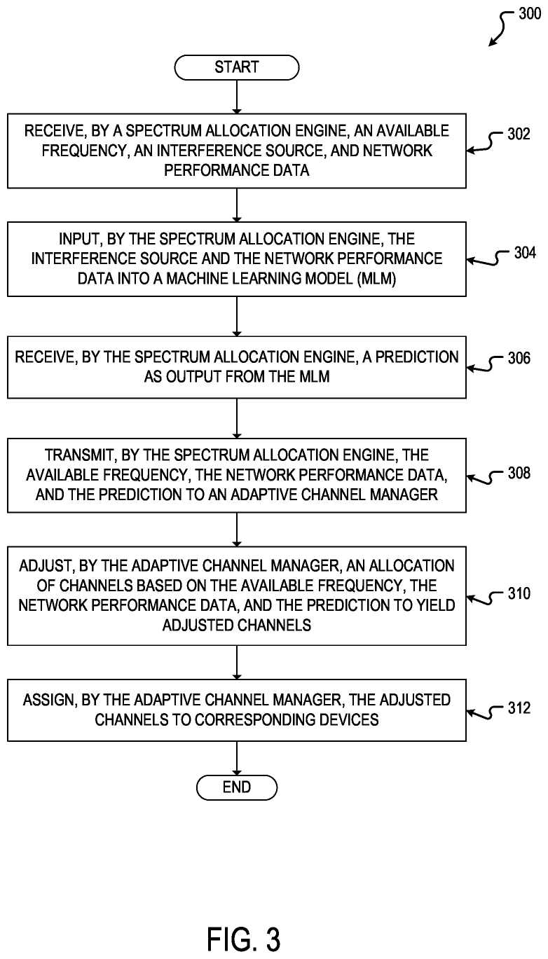

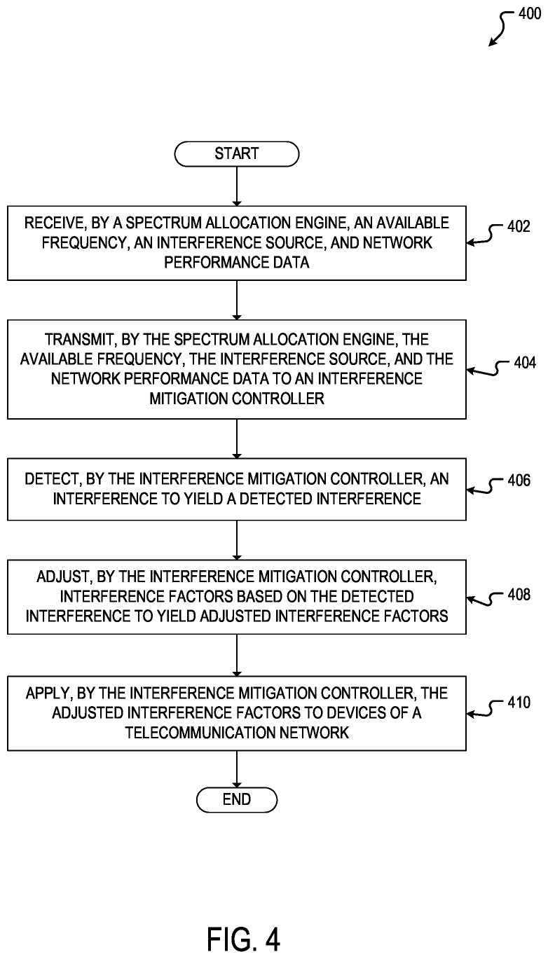

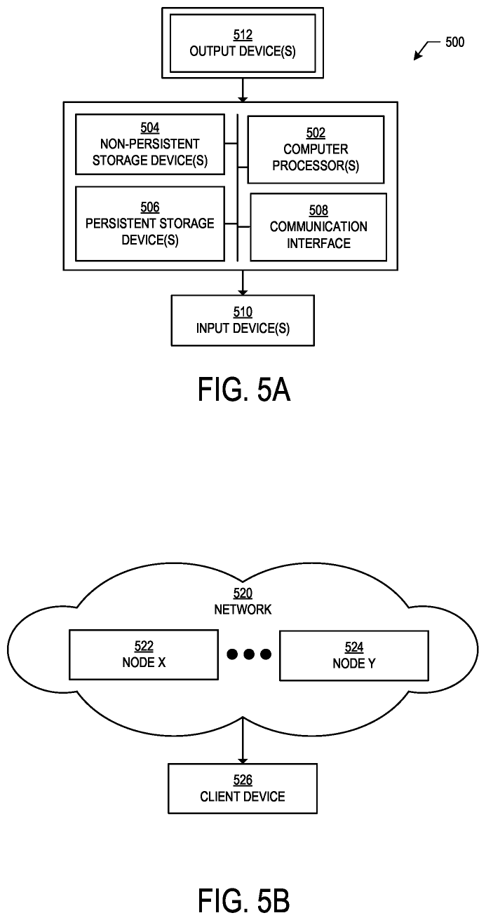

As shown, the system (100) includes a network module (102). The network module (102) is software or application specific hardware which, when executed by a computer processor such as a computer processor (502) (shown and described in FIG. 5A), is configured to process network sensor data from network sensor(s) (104) to, for example, determine network performance data that correlates to network performance of the telecommunications network. The network performance data can include, for example, network traffic patterns, current network loads, user device behaviors, application types, and/or bandwidth requirements. The network performance data can be used to, for example, predict future or anticipated network performance and/or demands, as described in more detail in FIG. 2, FIG. 3, and FIG. 4.

The network sensor(s) (104) are configured to sense, collect, and/or measure sensor data correlating to network data such as, for example, locations of devices in the network, spectrum data, spectrum data, protocol type and/or classification data, configuration data, scheduler data, device telemetry, etc. The network sensors (104) can include any number of network sensors such as one network sensor, two network sensors, or more than two network sensors.

The system (100) also includes a spectrum module (106). The spectrum module (106) is software or application specific hardware which, when executed by a computer processor such as the computer processor (502), is configured to process spectrum sensor data received from spectrum sensors (108) to, for example, determine an available frequency or frequencies in a frequency spectrum of the telecommunication network and/or to determine interference source(s) in the telecommunication network. The spectrum module (106) can be located in the access network as part of, for example, a radio frequency (RF) component. In other embodiments, the spectrum module (106) can be located anywhere in the telecommunication network.

The spectrum sensor(s) (108) are configured to sense, collect, and/or measure spectrum sensor data correlating to spectrum data such as, for example, signal strength, spectrum usage, bandwidth, available frequencies, non-available frequencies, channel allocation(s), etc. More specifically, the spectrum sensors (108) can detect unused frequency bands (e.g., spectrum holes) that can be utilized for transmission without interfering with licensed or primary users. Such unused frequency bands can be detected using techniques such as, for example, energy detection, matched filter detection, cyclostationary feature detection, waveform-based sensing, cooperative sensing, etc.

The spectrum sensors (104) can include any number of spectrum sensors such as one spectrum sensor, two spectrum sensors or more than two spectrum sensors. In at least one embodiment, the spectrum sensor(s) (108) can continuously monitor, for example, a wireless spectrum to measure or sense signal data across different frequencies and channels. In other embodiments, the spectrum sensor(s) (108) can monitor any type of spectrum.

The system (100) also includes a spectrum allocation engine (110). The spectrum allocation engine (110) is software or application specific hardware which, when executed by a computer processor such as the computer processor (502), is configured to receive the processed network sensor data from the network module (102) and the processed spectrum sensor data from the spectrum module (106). The spectrum allocation engine (110) is configured to input some of the processed data into the MLM (112) and/or transmit the processed data to other components in the system (100) such as, for example, an interference mitigation controller (114) and/or an adaptive channel manager (116). The spectrum allocation engine (110) is also configured to transmit outputs from the MLM (112) to the interference mitigation controller (114) and/or the adaptive channel manager (116).

The spectrum allocation engine (110) includes the MLM (112). In some embodiments, the MLM (112) is a reinforcement-based learning model. In other embodiments, the MLM (112) may be any type of learning model capable of using predictive analytics to predict interference and/or future network performance.

The MLM (112) is configured to process data in real-time from the network module (102), the spectrum module (106), user devices, or any other component(s) in the telecommunication network to make predictions that can be used to allocate channels in the frequency spectrum. More specifically, the MLM (112) is configured to output a prediction having at least a predicted future network performance and/or a predicted interference based on at least the interference source and the network performance data received as input. The MLM (112) may also receive any other input such as, for example, operator information, user device data, etc.

It will be appreciated that the MLM (112) can include more than one MLM and can include one MLM, two MLMs, or more than two MLMs. Further, other components such as, for example, the interference mitigation controller (114) and/or the adaptive channel manager (116) may also include MLM(s) (112). For example, the interference mitigation controller (114) can include an MLM (112) to predict potential interference scenarios based on potential interference sources and/or network performance data. In such example, the MLM (112) may also receive as input, or been trained on, historical network performance data and/or historical interference sources and trained to use predictive analytics to predict potential interferences.

The system (100) also includes the interference mitigation controller (“controller”) (114). The controller (114) is configured to mitigate interference by executing operations described in FIG. 2 and FIG. 4. The operations can include, for example, detecting an interference based the interference source (received from, for example, the spectrum allocation engine (110) or the spectrum module (106)) and/or the network performance data (received from, for example, the spectrum allocation engine (110) or the network module (102)), adjusting interference factors, and applying the adjusted interference factors to the telecommunication network.

The system (100) also includes an adaptive channel manager (116). The adaptive channel manager (116) dynamically adjusts an allocation of channels by evaluating a quality of each channel in terms of parameters such as, for example, a signal strength, a noise level, and interference (whether predicted or actual) and assigning new channels to improve a quality of service. New channels are assigned based on the real-time analysis of data from the network module (102), the spectrum module (106), and/or the spectrum allocation engine (110).

More specifically, the adaptive channel manager (116) is software or application specific hardware which, when executed by a computer processor such as the computer processor (502), dynamically allocates channels in the frequency spectrum by executing operations described in FIGS. 2 and 3. The operations can include, for example, adjusting an allocation of the channels based on the available frequency, the network performance data, and/or the prediction to yield adjusted channels and assigning the adjusted channels to corresponding devices of the telecommunication network. In other words, the adaptive channel manager (116) ensures optimal use of available spectrum by redistributing channels to avoid congestion and interference.

The system (100) also includes a user interface (118). Specifically, data from the spectrum allocation engine (110), the network module (102), the spectrum module (106), the interference mitigation controller (114), and/or the adaptive channel manger (116) may be presented by being displayed in a user interface (118), transmitted to a different computing system, and stored. The user interface (118) may include a graphical user interface (GUI) that displays information on a display device for, for example, monitoring predicted scenarios, potential or active mitigation actions, spectrum usage, interference levels, historical data, network performance reports, and/or telecommunication network performance. The user interface (118) can also enable users to make dynamic adjustments of network parameters and/or perform manual overrides and configuration of system parameters.

The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

The system (100) can include more or less components than shown. For example, the system (100) can include an interference prediction module to predict a future interference. In another example, the spectrum allocation engine (110), the interference mitigation controller (114), and/or the adaptive channel manager (116) may be integrated into a single module. In still another example, the network module (102) and/or the spectrum module (106) may be integrated into the same module.

FIG. 2 is a dataflow (200) of the dynamic spectrum allocation system (100) according to at least one embodiment of the present disclosure. As shown, the dataflow (200) begins with the network module (102) generating network performance data (220) from network sensor data received from the network sensor (104). As previously described, the network performance data (220) can include, for example, network traffic patterns, user behaviors, application types, and/or bandwidth requirements.

The dataflow (200) also begins with the spectrum module (106) generating an interference source (222) and an available frequency (224) from spectrum sensor data received from the spectrum sensor (108). The interference source (222) can include multiple interference sources (222) (e.g., if there are multiple interferences) and/or the available frequency (224) can include multiple frequencies (224).

The interference source (222) and/or the available frequency (224) can be generated by the spectrum module (106) processing the spectrum sensor data using signal processing techniques such as, for example, Fast Fourier Transform (FFT) and/or wavelet transform or other signal processing techniques, to identify anomalies and interference patterns and to analyze spectrum occupancy and utilization. The available frequency (224) can also be generated from using different detection techniques such as, for example, energy detection, matched filter detection, cyclostationary, feature detection, waveform-based sensing, cooperative sensing, etc. on the spectrum sensor data to identify the available frequency (224).

The dataflow (200) then includes the spectrum allocation engine (110) receiving the network performance data (220), the interference source (222), and the available frequency (224) in real-time from the network module (102) and the spectrum module (106). Processing the data (e.g., network performance data (220), the interference source (222), and the available frequency (224)) in real-time can include, for example, using stream processing frameworks to handle large streams of data with low latency, processing data in sliding windows to allow for continuous analysis of data as the data arrives, splitting data processing tasks across multiple nodes in a distributed system to enable parallel computation and increase processing times, utilizing multi-core processors to run parallel threads or processes, using representative samples of data by selecting the most relevant features and applying compression algorithms to reduce the size of the data to make processing more manageable, and/or using advanced indexing techniques to speed up data retrieval and optimize database queries to reduce processing time.

As shown, the dataflow (200) includes two branches, and in one branch the spectrum allocation engine (110) inputs the network performance data (220) and the interference source (222) into the MLM (112). In response to the inputs, the MLM (112) outputs a prediction (226) having at least a predicted network performance (228) and a predicted interference (230). In some instances, the prediction (226) can include more or less predictions.

The predicted network performance (228) is generated based on the network performance data (220) and the predicted interference (230) is generated based on the interference source (222). In some embodiments, the MLM (112) is trained using labeled datasets having, for example, historical network performance data, historical interferences, and historical interference sources. In such embodiments, unsupervised learning techniques, such as clustering and anomaly detection, can be used to discover new interference patterns and/or network performance patterns. The MLM (112) is further continuously updated with new data, enabling the MLM (112) and the system (100) to adapt to changing network conditions and emerging interference sources.

Continuing in the first branch of the dataflow (200), the prediction (226) is received by the adaptive channel manager (116). The spectrum allocation engine (110) also transmits the available frequency (224) and the network performance data (220) to the adaptive channel manager (116). Alternatively, the adaptive channel manager (116) can receive the available frequency (224) and the network performance data (220) from the spectrum module (106) and the network module (102), respectively.

The adaptive channel manager (116) adjusts an allocation of channels in the frequency spectrum based on the available frequency (224), the network performance data (220), and the prediction (226) to yield adjusted channels (232). The adjusting executed by the adaptive channel manager (116) is configured to minimize the predicted interference (230) and to optimize the predicted network performance (228) based on, for example, congestion and/or interference levels, bandwidth requirement for specific traffic and/or applications, airtime utilization, etc. For example, if a channel is determined to not satisfy a target user experience, a new channel can be assigned. Further examples of adjusting by the adaptive channel manager (116) include evaluating predicted interference levels across potential channels, avoiding allocating channels with high expected co-channel or adjacent-channel interference, selecting channels with lower predicted noise and congestion levels, and/or distributing devices across channels to reduce channel contention and overlapping transmissions.

After the allocation of channels are adjusted, the adaptive channel manager (116) assigns the adjusted channels to corresponding devices (234) in the telecommunication network. The devices (234) can include, for example, user equipment such as computer devices, mobile devices, computer tablets, etc. The devices (234) can also include network devices such as, for example, access network devices, base stations, transmitters, receivers, amplifiers, antennas, the network sensors (104), the spectrum sensors (108), etc.

Returning to the spectrum allocation engine (110), in another branch of the dataflow (200), the spectrum allocation engine (110) transmits the available frequency (224), the network performance data (220), and/or the interference source (222) to the interference mitigation controller (114). Alternatively, the interference mitigation controller (114) can receive the available frequency (224) and the interference source (222) from the spectrum module (106) and/or the network performance data (220) from the network module (102).

As previously described, the interference mitigation controller (114) is configured to mitigate interference by detecting the interference based on the interference source (222) and the network performance data (220) to yield a detected interference (236). Such detected interference (236) can include an assessment of severity and impact on network performance.

The interference mitigation controller (114) also adjusts interference factors based on the detected interference (236), the network performance data (220), and/or the available frequency (224) to yield adjusted interference factors (238). The interference factors are adjusted to minimize the detected interference (236). Adjusting the interference factors to minimize the detected interference (236) can include, for example, adjusting a transmission power, changing channel(s), switching channels to less congested frequencies, beamforming and focusing signal transmission in specific directions, and/or using advanced modulation schemes such as, for example, Quadrature Amplitude Modulation (QAM), Orthogonal Frequency Division Multiplexing (OFDM), Orthogonal Frequency Division Multiple Access (OFDMA), Phase Shift Keying (PSK), Trellis Coded Modulation (TCM), Continuous Phase Modulation (CPM), Filtered Multitone Modulation (FMT), Pulse Amplitude Modulation (PAM), Polarization Division Multiplexing (PDM), Spatial Modulation (SM), Hybrid Modulation Schemes, etc.

The interference mitigation controller (114) is also configured to apply the adjusted interference factors (238) to the devices (234) of the telecommunication network. For example, in some embodiments, the interference mitigation controller (114) may transmit controls or instructions to the devices (234) to adjust one or more factors of the device (234).

The dataflow (200) illustrated can be continuously repeated such that the system (100) adapts to changing network conditions and performances, and redistributes spectrum resources as needed. Further, the system (100) can make preemptive adjustments to avoid predicted or anticipated future interference and network demands as provided by the predictive analytics of the MLM (112).

FIG. 3 is a flowchart of a method (300) according to at least one embodiment of the present disclosure. The method (300) is a method for dynamic spectrum allocation in a telecommunication network. The method (300) can be performed using, for example, a dynamic spectrum allocation system such as the dynamic spectrum allocation system (100).

Step 302 of the method (300) provides for receiving, by a spectrum allocation engine, an available frequency, an interference source, and network performance data. The spectrum allocation engine may be the same as or similar to the spectrum allocation engine (110), the available frequency may be the same as or similar to the available frequency (224), the interference source may be the same as or similar to the interference source (222), and the network performance data may be the same as or similar to the network performance data (220).

As previously described, the spectrum allocation engine may receive the available frequency and the interference source from a spectrum module such as the spectrum module (106) and the network performance data from a network module such as the network module (102). The spectrum allocation engine may receive the available frequency, the interference source, and network performance data in real-time.

Step 304 of the method (300) provides for inputting, by the spectrum allocation engine, the interference source and the network performance data into a machine learning model (MLM). The MLM may be the same as or similar to the MLM (112). The MLM is configured to output a prediction such as the prediction (226) having at least a predicted network performance such as the predicted network performance (228) and/or a predicted interference such as the predicted interference (230). The predicted network performance may be based on the network performance data, and the predicted interference may be based on the interference source.

Step 306 of the method (300) provides for receiving, by the spectrum allocation engine, the prediction as output from the MLM. Step 308 of the method (300) provides for transmitting, by the spectrum allocation engine, the available frequency, the network performance data, and the prediction to an adaptive channel manager. The adaptive channel manager may be the same as or similar to the adaptive channel manager (116). In some embodiments, the adaptive channel manager may receive the available frequency from the spectrum module and the network performance data from the network module.

Step 310 of the method (300) provides for adjusting, by the adaptive channel manager, an allocation of channels based on the available frequency, the network performance data, and the prediction to yield adjusted channels. The adjusted channels may be the same as or similar to the adjusted channels (232).

As previously described, the adjusting of step 310 is configured to minimize the predicted interference and to optimize the predicted network performance. Examples of adjusting by the adaptive channel manager include evaluating predicted interference levels across potential channels, avoiding allocating channels with high expected co-channel or adjacent-channel interference, selecting channels with lower predicted noise and congestion levels, and/or distributing devices across channels to reduce channel contention and overlapping transmissions.

Step 312 of the method (300) provides for assigning, by the adaptive channel manager, the adjusted channels to corresponding devices. The devices may be the same as or similar to the devices (234).

The method (300) described in FIG. 3 can include more or less steps. One or more steps or any combination of steps may also be repeated in the method described in FIG. 3.

FIG. 4 is a flowchart of a method (400) according to at least one embodiment of the present disclosure. The method (400) is a method for mitigating interference in a telecommunication network. The method (400) can be performed using, for example, a dynamic spectrum allocation system such as the dynamic spectrum allocation system (100).

Step 402 of the method (400) provides for receiving, by a spectrum allocation engine, an available frequency, an interference source, and network performance data. The step 402 may be the same as or similar to the step 302 of FIG. 3, described above.

Step 404 of the method (400) provides for transmitting, by the spectrum allocation engine, the available frequency, the interference source, and the network performance data to an interference mitigation controller. Alternatively, the interference mitigation controller can receive the available frequency and the interference source from the spectrum module and/or the network performance data from the network module. The interference mitigation controller may be the same as or similar to the interference mitigation controller (114).

Step 406 of the method (400) provides for detecting, by the interference mitigation controller, an interference to yield a detected interference. The interference mitigation controller may detect the interference based on the interference source. For example, the interference mitigation controller can detect the interference.

Step 408 of the method (400) provides for adjusting, by the interference mitigation controller, interference factors based on the detected interference to yield adjusted interference factors. The interference factors can include, for example.

Step 410 of the method (400) provides for applying, by the interference mitigation controller, the adjusted interference factors to devices. The devices may be the same as or similar to the device (234) of the telecommunication network.

The method (400) described in FIG. 4 can include more or less steps. One or more steps or any combination of steps may also be repeated in the method described in FIG. 4.

The dynamic spectrum allocation system (100) as described herein improves wireless network performance by optimizing spectrum usage for higher speeds, lower latency, and reduced interference. The system (100) enhances reliability through continuous monitoring and real-time adjustments, while maximizing spectrum efficiency with dynamic allocation of channels in the frequency spectrum. Further, the system's (100) adaptive and scalable design also supports changing conditions and large network deployments, and proactive interference management uses predictive analytics to prevent issues before they occur.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to, or be a part of, a network. For example, as shown in FIG. 5B, the network (520) may include multiple nodes (e.g., node X (522) and node Y (524), as well as extant intervening nodes between node X (522) and node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, i.e., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of dynamic spectrum allocation for a telecommunication network, the method comprising:
receiving, by a spectrum allocation engine of the telecommunication network:
at least one available frequency in a frequency spectrum and at least one interference source from a spectrum module,
network performance data from a network module;
inputting, by the spectrum allocation engine, the at least one interference source and the network performance data into a machine learning model (MLM), the MLM configured to output a prediction comprising a predicted network performance and a predicted interference based on the at least one interference source and the network performance data;
receiving, by the spectrum allocation engine, the prediction as output from the MLM; and
transmitting, by the spectrum allocation engine, the at least one available frequency, the network performance data, and the prediction to an adaptive channel manager configured to dynamically allocate one or more channels in the frequency spectrum by executing a plurality of operations comprising:
adjusting an allocation of the one or more channels based on the at least one available frequency, the network performance data, and the prediction to yield one or more adjusted channels, wherein the adjusting is configured to minimize the predicted interference and to optimize the predicted network performances; and
assigning the one or more adjusted channels to a corresponding one or more devices in the telecommunication network.

2. The method of claim 1, wherein the adjusting comprises at least one of avoiding channels with an expected co-channel or adjacent-channel interference that exceeds a predetermined interference threshold, selecting a channel with a predicted noise and congestion level lower than a current predicted noise and congestion level, or distributing devices across channels to reduce channel contention and overlapping transmissions.

3. The method of claim 1, wherein the MLM uses reinforcement learning (RL) and is trained using historical data as training data.

4. The method of claim 1, wherein the MLM is fined-tuned using real-time data.

5. The method of claim 1, wherein the adjusting the allocation of the one or more channels is further based on one or more user inputs.

6. The method of claim 1, further comprising:
transmitting, by the spectrum allocation engine, the at least one available frequency, the at least one interference source, and the network performance data to an interference mitigation controller configured to mitigate interference by executing a plurality of operations comprising:
detecting the interference based on the at least one interference source and the network performance data to yield a detected interference;
adjusting one or more interference factors based on the detected interference, the network performance data, and the at least one available frequency to yield one or more adjusted interference factors, wherein the adjusting is configured to minimize the detected interference; and
applying the one or more adjusted interference factors to the one or more devices of the telecommunication network.

7. The method of claim 6, wherein adjusting the one or more interference factors includes at least one of dynamic frequency selection, adjusting a transmission power, beamforming, or adjusting the allocation of the one or more channels.

8. The method of claim 1, wherein the at least one frequency band is detected by a spectrum sensor using at least one of energy detection, matched filter detection, cyclostationary feature detection, waveform-based sensing, or cooperative sensing.

9. The method of claim 1, wherein the network performance data is generated from network sensor data received and processed by the network module from a network sensor.

10. The method of claim 1, wherein the frequency spectrum comprises a wireless frequency spectrum.

11. A method of mitigating interference in a telecommunication network, the method comprising:
receiving, by a spectrum allocation engine of the telecommunication network:
at least one available frequency and at least one interference source from a spectrum module,
network performance data from a network module;
transmitting, by the spectrum allocation engine, the at least one available frequency, the at least one interference source, and the network performance data to an interference mitigation controller configured to mitigate interference by executing a plurality of operations comprising:
detecting the interference based on the at least one interference source and the network performance data to yield a detected interference;
adjusting one or more interference factors based on the detected interference, the network performance data, and the at least one available frequency to yield one or more adjusted interference factors, wherein the adjusting is configured to minimize the detected interference; and
applying the one or more adjusted interference factors to one or more devices of the telecommunication network.

12. The method of claim 11, wherein adjusting the one or more interference factors includes at least one of dynamic frequency selection, adjusting a transmission power, beamforming, or adjusting the allocation of the one or more channels.

13. The method of claim 11, wherein the at least one frequency band is detected by a spectrum sensor using at least one of energy detection, matched filter detection, cyclostationary feature detection, waveform-based sensing, or cooperative sensing.

14. The method of claim 11, wherein the network performance data is generated from network sensor data received and processed by the network module from a network sensor.

15. The method of claim 11, wherein the frequency spectrum comprises a wireless frequency spectrum.

16. The method of claim 11, further comprising:
inputting, by the spectrum allocation engine, the at least one interference source and the network performance data into a machine learning model (MLM), the MLM configured to output a prediction comprising a predicted network performance and a predicted interference based on the at least one interference source and the network performance data;
receiving, by the spectrum allocation engine, the prediction as output from the MLM; and
transmitting, by the spectrum allocation engine, the at least one available frequency, the network performance data, and the prediction to an adaptive channel manager configured to dynamically allocate one or more channels in the frequency spectrum by executing a plurality of operations comprising:
adjusting an allocation of the one or more channels based on the at least one available frequency, the network performance data, and the prediction to yield one or more adjusted channels, wherein the adjusting is configured to minimize the predicted interference and to optimize the predicted network performances; and
assigning the one or more adjusted channels to a corresponding one or more devices in the telecommunication network.

17. The method of claim 11, wherein the adjusting comprises at least one of avoiding channels with an expected co-channel or adjacent-channel interference that exceeds a predetermined interference threshold, selecting a channel with a predicted noise and congestion level lower than a current predicted noise and congestion level, or distributing devices across channels to reduce channel contention and overlapping transmissions.

18. The method of claim 11, wherein the MLM uses reinforcement learning (RL) and is trained using historical data as training data.

19. The method of claim 11, wherein the adjusting the allocation of the one or more channels is further based on one or more user inputs.

20. A dynamic spectrum allocation system for a telecommunication network, the system comprising:
a spectrum module comprising at least one sensor, the spectrum module configured to determine at least one available frequency in a frequency spectrum and at least one interference source based on sensor data received from the at least one spectrum sensor;
a network module comprising at least one network sensor, the network module configured to determine network performance data based on network sensor data received from the at least one network sensor;
a machine learning model (MLM) configured to output a prediction comprising a predicted future network performance and a predicted interference based on the at least one interference source and the network performance data received as input;
an adaptive channel manager configured to dynamically allocate one or more channels in the frequency spectrum by executing a plurality of operations comprising:
adjusting an allocation of the one or more channels based on the at least one available frequency, the network performance data, and the prediction to yield one or more adjusted channels, wherein the adjusting is configured to minimize the predicted interference and to optimize the predicted network performances; and
assigning the one or more adjusted channels to one or more corresponding devices of the telecommunication network; and
a spectrum allocation engine configured to:
input the at least one interference source and the network performance data into the MLM; and
transmit the prediction received as output from the MLM, the at least one available frequency, and the network performance data to the adaptive channel manager.
